(19) United States
(12) Patent Application Publication
(10) Pub. No.: US 2004/0054703 A1
(43) Pub. Date: Mar. 18, 2004

(54) Method and device for generating a pseudo-random sequence using a discrete logarithm

(76) Inventors: Klaus Huber, Darmstadt (DE); Ulrich Heister, Dieburg (DE); Frank Schaefer-Lorinser, Ober-Ramstadt (DE); Tobias Martin, Rabenau (DE); Thomas Breitbach, Nickenich (DE)

Correspondence Address: KENYON & KENYON, ONE BROADWAY, NEW YORK, NY, 10004, US

(21) Appl. No.: 10/450,188

(22) PCT Filed: Sep. 14, 2001
(86) PCT No.: PCT/EP01/10650

(30) Foreign Application Priority Data
Dec. 8, 2000 (DE) 100 61 315.2

(51) Int. Cl. G06F 7/58; G06F 1/02; H04L 9/00

(52) U.S. Cl. 708/252; 708/250; 380/46

(57) ABSTRACT

A method and/or system is provided for generating pseudo-random sequences. The method and/or system may provide that the elements (γ) of the pseudo-random sequences are discretely logarithmized.

### FIELD OF THE INVENTION

The present invention relates to a method and/or device for generating a pseudo-random sequence.

### BACKGROUND INFORMATION

Random sequences may be generated in two distinct ways. True random sequences are generated on the basis of physical effects, such as radioactive decay. These true random sequences can have practical applications in cryptography. In another variant, pseudo-random sequences may be generated by a device, also referred to as a (pseudo) random generator. Such a device can be a computer which, for example, processes an algorithm operation. Besides this software implementation, pseudo-random sequences can also be generated using shift registers implemented as hardware, which, for the most part, may have linear feedback. A difference between pseudo-random sequences and true random sequences may include that pseudo-random sequences can be repeated, i.e., reconstructed, when one has knowledge of the circuit arrangement and/or algorithm.

Reference European Patent Application No. 0 616 429 may describe an example method and a circuit arrangement for generating a pseudo-random sequence. The described circuit arrangement appears to be implemented by a feedback shift register, in which a plurality of series-connected memory cells or flip-flops are provided. At least two output values from various memory cells are read off and linked to one another in a logic device. The result of the logic operation is apparently fed back to the input of the shift register. A plurality of feedback paths may be used. The logic operation linking the two output values of the two memory cells is described to perform using a modulo 2 addition, which is executed by an exclusive-OR gate. An application of this reference may be, e.g., the so-called stream ciphering.

### SUMMARY OF THE INVENTION

Exemplary embodiments and/or exemplary methods of the present invention are directed to providing a source for generating a pseudo-random sequence.

Exemplary embodiments and/or exemplary methods of the present invention are directed to generating a pseudo-random sequence which, in a shift register implemented as hardware or software, has a plurality of series-connected memory cells, the elements of the pseudo-random sequence being shifted by the shift register. The output values from at least two shift register stages may be linked to one another. The result of the logic operation may be fed to the input of one of the shift register stages of the shift register chain. The elements of the pseudo-random sequence may be discretely logarithmized.

Exemplary embodiments and/or exemplary methods of the present invention involve discrete logarithmization which means that one does not take the logarithm of the whole of the pseudo-random sequence, but rather of the individual elements of the pseudo-random sequence. In exemplary embodiments and/or exemplary methods of the present invention, it may be provided that two elements of the pseudo-random sequence are logically linked to one another by the logarithmization.

In exemplary embodiments and/or exemplary methods of the present invention, the logarithm is taken in a modified, discrete operation. If, e.g., the logarithm is not defined at the zero position—provided that one element assumes the value zero—the logarithmization may not be implemented, and instead a predefinable value may be then set.

In exemplary embodiments and/or exemplary methods of the present invention, the logarithm may be taken in a discrete operation already at the time that the output values of the shift register stages are logically combined. In further exemplary embodiments and/or exemplary methods, one may first generate the pseudo-random sequence and subsequently take the logarithm in a discrete operation at the output of the shift register chain, as described above. One may also repeatedly take the logarithm in a discrete operation. In this way, other pseudo-random sequences may be generated, in turn.

Exemplary embodiments and/or exemplary methods of the present ivnention are directed to providing for the logarithm to be taken discretely out on the basis of a logarithm table including output and result values. This can mean that the output value of a memory cell is compared to the values of the logarithm table, the result matching the output value is selected, and this is routed as the result of the logic operation to an input of a memory cell.

In exemplary embodiments and/or exemplary methods of the present invention, one of the output values to be linked to one another may linked in an initial or preceeding logic operation to a predefinable value, prior to this logic operation, thus, before the logarithms are taken discretely. For this initial logic operation, a logic operation, e.g., an addition operation, may be provided. Thus, if in the context of the addition operation, the output value of the shift register is linked to a zero, then the feedback path may be consequently switched on and, therefore, be active, since the output value of the shift register is always passed on. If the output value of the shift register is linked to a one, the feedback path could thereby be disabled. Of course, predefinable values other than zero or one may also be used for the initial logic operation.

Exemplary embodiments and/or exemplary methods of the present invention are directed to providing for the initial logic operation to be performed on the basis of an initial-logic-operation table including output and result values, or for it to be performed by using logic circuitry.

Exemplary embodiments and/or exemplary methods of the present invention are directed to providing that logarithms are discretely taken using the so-called Zech or Jacobi logarithm. If logarithms are discretely taken using the above-mentioned tables, the result values in this table may be ascertained using the Zech or Jacobi logarithm. Thus, the logarithm table may be based on the available Zech or Jacobi logarithms.

Exemplary embodiments and/or exemplary methods of the present invention are directed to providing that the feedback operation is carried out in such a way that a pseudo-random sequence having a maximum period length is generated. This means that the at least one feedback path is provided at specific outputs of the shift register stages. To ascertain the feedback connections, that is, the feedback paths which provide the maximum period length of the pseudo-random sequence, tables are available via references, including, e.g., W. Peterson, E. Weldon, Error-Correcting Codes, second edition, MIT Press, Cambridge, seventh printing 1984,; and R. Lidl, H. Niederreiter, Finite Fields, Cambridge University Press 1984.

Exemplary embodiments and/or exemplary methods of the present invention are directed to providing a device for generating a pseudo-random sequence which includes a plurality of serially connected memory cells which form a shift register. In further exemplary embodiments and/or exemplary methods, a feedback path may be provided which connects two different register outputs to one register input. Moreover, a logic element may be provided for the output values of the register stages which is connected on the input side to the register outputs and, on the output side, to the register input. The exemplary device includes an element for discretely logarithmizing the elements of the pseudo-random sequence. Thus, exemplary embodiments and/or exemplary methods of the present invention provide a source for generating pseudo-random sequences, which supplies pseudo-random sequences that are different from available random sequences.

Exemplary embodiments and/or exemplary methods of the present invention are directed to providing that the element used for discretely taking logarithms is located in the feedback path and forms the logic element which discretely takes the logarithms of the output values of the register.

Alternatively, it may also be provided, for the element for discretely taking logarithms to be placed at the end of the shift register chain.

Exemplary embodiments and/or exemplary methods of the present ivention are directed to providing that the element is a memory element in which a logarithm table including output and result values is stored. Alternatively, the element may be implemented by logic modules, thus as hardware.

Exemplary embodiments and/or exemplary methods of the present invention are directed to providing that situated between one of the register outputs and the logic element is an initial-logic-operation element, whose one input is connected to this register output, whose other input is able to receive a predefinable value, and whose output is connected to the input of the logic element. Thus, one may switch the feedback path or a plurality of feedback paths on and off, i.e., to activate or deactivate them.

Exemplary embodiments and/or exemplary methods of the present invention are directed to providing that the initial-logic-operation element is a logic circuit, e.g., an exclusive OR gate. In further exemplary embodiments and/or exemplary methods of the present invention, the initial-logic-operation element may be implemented by a memory element, in which the initial-logic-operation results are stored as a function of the input values.

### BRIEF DESCRIPTION OF THE DRAWINGS

FIG. 1 shows a linear-feedback, binary shift register having one element for discretely taking logarithms.

FIG. 2 shows a linear-feedback, ternary shift register having one element for discretely taking logarithms.

FIG. 3 shows a general, linear-feedback shift register having one element for discretely taking logarithms.

FIG. 4 shows a linear-feedback shift register over the field GF (2²)=GF (4).

FIG. 5 shows a linear-feedback shift register over the field GF (2²)=GF (4), the element for discretely taking logarithms being disposed in the feedback path.

FIG. 6 shows a general, linear-feedback shift register having one element for discretely taking logarithms, in the feedback paths.

### DETAILED DESCRIPTION

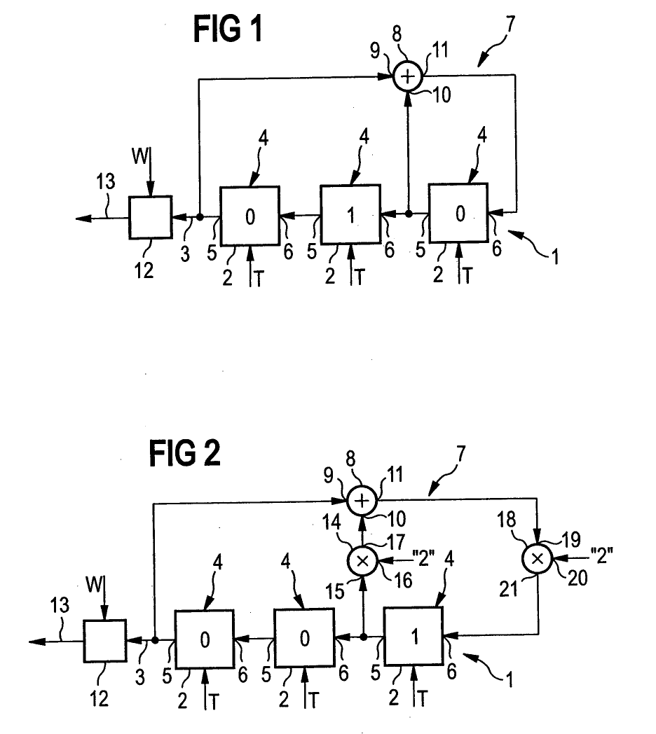

FIG. 1 shows an exemplary embodiment in which a shift register chain 1 has a number m of serially connected memory cells 2. The input of a shift register stage is connected to the output of the preceding shift register stage. The last shift register stage forms output 3 of chain 1 where the pseudo-random sequence is able to be read off. In some cases, to generate pseudo-random sequences, these so-called linear feedback shift register chains 1 may be used, which can be manufactured in an integrated form, as hardware, thus using fast logic modules, making a very high processing speed attainable. FIG. 1 shows a binary shift register chain of this kind. Each shift register stage 2 is supplied with a clock timing T, so that, at every clock pulse, the active value at the input of a shift register stage 2 is read into memory cell 4 of the particular shift register stage 2, and the element of the pseudo-random sequence previously stored in memory cell 4 is made available at register output 5. A central clock may be provided for the clock-time. The input of each memory cell is provided in FIG. 1 with reference numeral 6.

Configured in feedback path 7 of binary shift register chain 1 is a logic element 8, whose inputs 9 and 10 are connected to register outputs 5. Output 11 of logic element 8 is connected to input 6 of a shift register stage, e.g., of the first shift register stage. In this example, the logic element is displayed as a summing device, which adds the output values of the register available at inputs 9 and 10, where it holds that 0+0=0, 0+1=1+0=1 and 1+1=0 mod 2. This addition modulo 2 may be executed using a logic gate implemented as an exclusive-OR gate. Thus, given the initial assignment of memory cells 4 of shift register chain 1 illustrated in FIG. 1, a pseudo-random sequence may be able to be generated using elements 0100111010 . . . . This pseudo-random sequence is available at output 3 of the shift register chain, i.e., may be read off at this output 3.

In this example, the pseudo-random sequence made available at output 3 is discretely logarithmized. For this purpose, a logarithmization element 12, which discretely logarithmizes the elements of the pseudo-random sequence, is connected in outgoing circuit to output 3. For the discrete logarithmization, it may be provided that one element of the pseudo-random sequence is linked to another element of the pseudo-random sequence. It may also be provided, however, that one element of the pseudo-random sequence is linked to a predefinable value W active at element 12.

The discretely logarithmized pseudo-random sequence may be available at element output 13. Logarithms are taken in a preferably modified, discrete operation. This means that, if an element of the pseudo-random sequence has the value 0, the element may be set to a predefinable result value, since it is not possible to take the logarithm of 0.

With respect to the linear feedback shift register 1, one may determine the parameters, in order to attain the maximum possible period length of the pseudo-random sequence. As parameters, in this case, register outputs 5 are to be indicated, whose output values must be linked in logic element 8. Thus, the position of the feedback connections should be indicated, and also which register input 6, output 11 of the logic element must be connected should be indicated. A binary, linear feedback shift register chain 1 having length m, thus the number of shift register stages 2, may generate a pseudo-random binary sequence which does not repeat itself until after 2-1 bits. One may find tables including feedback connections, which indicate the maximum period length in references, e.g., W. Peterson, E. Weldon, Error-Correcting Codes, second edition, MIT Press, Cambridge, 7^{th} ed., 1984; and R. Lidl, H. Niederreiter, Finite Fields, Cambridge University Press, 1984.

Instead of the binary shift register sequences, one may also use non-binary sequences. A non-binary shift register chain 1 is shown in FIG. 2. In contrast to shift register chain 1 in accordance with FIG. 1, an initial-logic-operation element 14 is interconnected between input 10 of logic element 8 and register output 5. This element has two initial-logic-operation inputs 15 and 16, as well as one initial-logic-operation output 17, which is connected to input 10 of initial-logic-operation element 8. In an embodiment, initial-logic-operation element 14 performs a multiplication. Thus, in shift register chain 1, logic element 8 and initial-logic-operation element 14 constitute the addition and multiplication modulo 3. In other words, one performs the addition and/or multiplication of the numbers from the set {0, 1, 2} and subtracts value 3 from the result, when it is greater than 2. From this, a pseudo-random sequence having elements 00111021121010022201221202001 . . . can be derived at output 3 of shift register chain 1. This pseudo-random sequence may be fed to logarithmization element 12, as in shift-register chain 1 in FIG. 1. An additional multiplication element 18, which is identical in design to initial-logic-operation element 14, may be configured in feedback path 7. Input 19 of the multiplication element is linked to output 11 of logic element 8. For the function modulo 2, second input 20 of the multiplication element receives the corresponding input parameter. Output 21 of multiplication element 18 is connected to input 6 of first shift register stage 2. Equivalent parts, i.e., parts performing essentially equivalent functions as in FIG. 1, are denoted by the same reference numerals in FIG. 2.

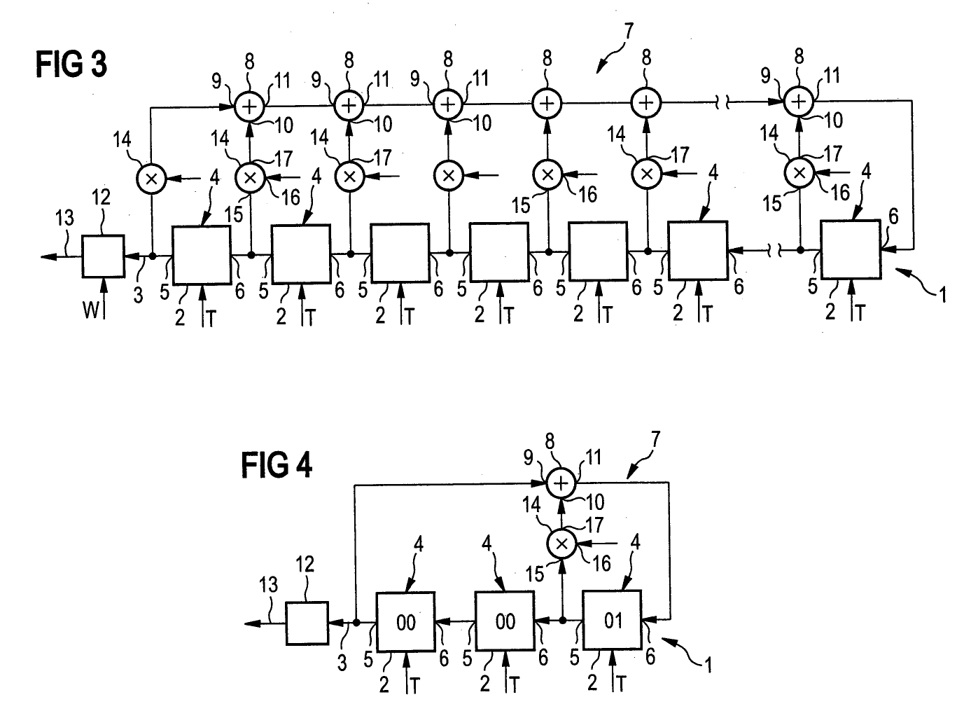

FIG. 3 shows a shift register chain 1, which, as alphabet GF(q), uses a so-called binary extension field, where q=2. Binary extension fields are very well suited for the binary format commonly used in data processing. The linear feedback shift-register chain 1 then may have the form illustrated in FIG. 3. Thus, here, as in FIG. 2, initial-logic-operation elements 14 are provided, each of which are situated between the output of a shift-register stage and the input of logic element 8. Re FIG. 3, each shift-register output 5 may be fed back via an initial-logic-operation element 14 and a logic element 8, thus to an input 6 of another shift-register stage, the logic operations performed in connection with FIGS. 1 and 2, being implemented in initial-logic-operation elements 14 and logic elements 8. Equivalent parts, i.e., parts performing essentially equivalent functions, are denoted in FIG. 3 by the same reference numerals as in FIGS. 1 and 2.

On the basis of FIG. 3, the following considers a shift register chain 1 over alphabet GF (q), GF (q) characterizing a field having q=p elements, q representing a prime power. The structure of the linear feedback shift-register stages is essentially retained. As illustrated in FIGS. 1 through 4, the pseudo-random sequence may be manipulated via the slightly modified, discrete logarithm formation, the computational operations necessary for the logarithm formation being shifted into a number set in which the required operations are easily implemented by most calculators/processors. At this point, instead of the multiplication in the initial-logic-operation element 14, the addition modulo p−1 is now performed, and, instead of the addition in logic element 8, a comparable substitute operation may be performed, it being possible to use a table to carry out these substitute operations. Logic element 8 may contain a memory for such a table, from which an appropriate result value is selected as a function of the input values.

The pseudo-random sequences obtained differ from the sequences generated by related-art feedback shift registers. The period length of the pseudo-random sequence is able to be exactly determined on the basis of the structure of the linearly coupled shift register chain. The period length is given by the period length of the underlying shift register.

If one takes, for example, shift register chain 1 shown in FIG. 4, having number m=3 shift register stages, over field GF (2²)=(00,01,10,11), then one obtains a pseudo-random sequence having the period length 4³−1=63. In FIG. 4, the individual elements of field GF are shown in memory cell 4 of each shift register 2.

To calculate the elements of field GF, the two tables listed in the following may be used, for example, for the addition and multiplication operations in this field. Thus, these tables include output values, to which corresponding result values are uniquely assigned. These tables may be invoked and processed in logic elements 8 and 14.

Addition table

| + | 0 | 1 | 10 | 11 |
|---|---|---|---|---|
| 0 | 0 | 1 | 10 | 11 |
| 1 | 1 | 0 | 11 | 10 |
| 10 | 10 | 11 | 0 | 1 |
| 11 | 11 | 10 | 1 | 0 |

Multiplication table

| X | 0 | 1 | 10 | 11 |
|---|---|---|---|---|
| 0 | 0 | 0 | 0 | 0 |
| 1 | 0 | 1 | 10 | 11 |
| 10 | 0 | 10 | 11 | 1 |
| 11 | 0 | 11 | 1 | 10 |

Addition operations, namely, as component-by-component exclusive-OR logic operations, are quite simple in binary extension fields GF, whereas multiplication operations in extension fields are more complicated. They may be performed by special circuitry or through the use of tables.

On the basis of the initial assignment of memory cells 4 with 00, 00 and 01, as shown in FIG. 4, one obtains the sequence 00 00 01 11 10 00 11 00 00 11 10 01 00 10 00 00 10 01 11 01 . . . for the shift register chain according to FIG. 4. This obtained pseudo-random sequence may be discretely logarithmized by element 12, as in the preceding examples according to FIGS. 1 through 3.

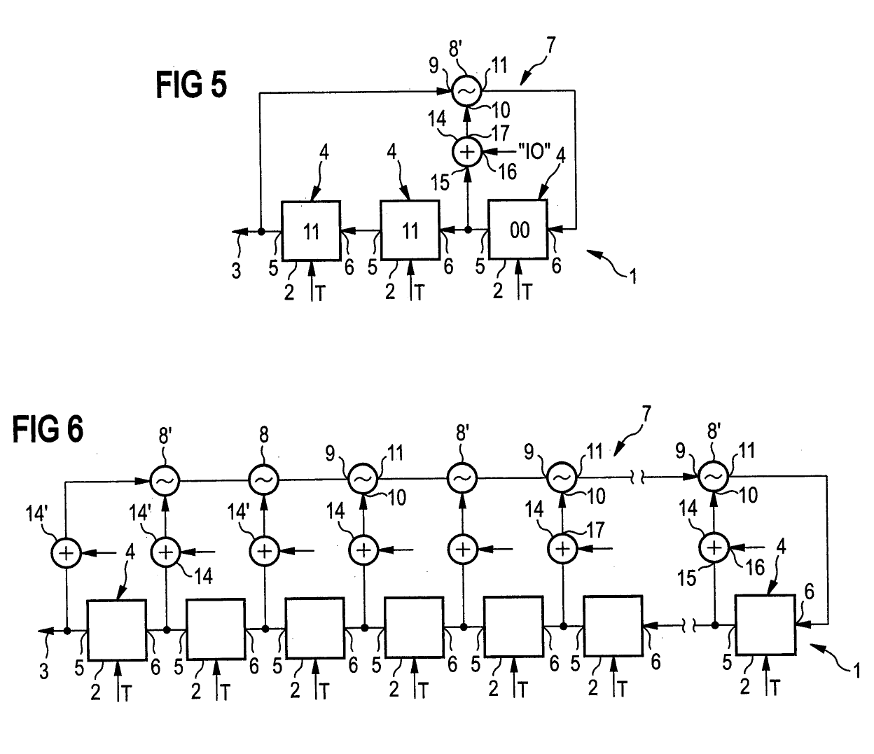

In the place of elements 12, illustrated in FIGS. 1 through 4, for the modified, discrete logarithm operation at output 3 of shift register chain 1, an embodiment of shift-register chains 1 for generating pseudo-random sequences is described in the following on the basis of FIGS. 5 and 6. As mentioned, the discrete mapping is the modified, discrete logarithm formation and is explained in greater detail below. The main distinction from the above described exemplary embodiments lies in that the structures of shift register chain 1 of linear feedback shift register 2 are used, however, the logic operations in logic elements 8 and 14 are not implemented, as described above, as addition or multiplication operations, but rather replaced by the discrete logarithm formation. This means that element 12 previously linked to output 3 is now shifted into feedback path 7. Thus, logic element 8 takes over the modified, discrete logarithm formation.

The required computational operations are shifted into a number set in which the operations required for the logic operation are able to be implemented by the calculators/processors. Instead of the Galois field multiplication in the initial-logic-operation element 14, the addition modulo p−1 is essentially performed, and, instead of the addition in logic element 8, a comparable substitute operation is performed, which may be carried out, for example, using logic modules or also by using a table. This substitute operation is labeled in FIGS. 5 and 6 by reference character ˜. Thus, logic element 8′ in feedback path 7 (FIG. 5) and logic elements 8′ in feedback path 7 (FIG. 6), respectively, perform the modified, discrete logarithm formation. On the other hand, in initial-logic-operation elements 14 or in initial-logic-operation element 14′, the addition modulo p−1 is carried out.

The function of shift register chains 1 is described in the following in accordance with FIGS. 5 and 6. It is known that, in a finite field GF (p), each field element γ different from 0 can be represented as a power of a so-called primitive element α, i.e., as αⁱ for i=0 . . . p−2. For Galois field GF (2²), one obtains, for example:

i γ=αⁱ

0 01

1 10

2 11

The discrete logarithm for field elements γ is defined as follows:

log (γ)=i for γ=αⁱ, i=0 . . . p−2.

If one adds to this the modification that log(γ)=p−1 for γ=0, then the slightly modified definition of the discrete logarithm is obtained that applies to the essence of the present invention.

For the case GF (2²), the following table is obtained for elements γ:

γ log (γ)

00 11 (corresponds to 3)

01 00 (corresponds to 0)

10 01 (corresponds to 1)

11 10 (corresponds to 2)

Logarithm Table

In this table, the integral values of log(γ) are rendered in a binary representation. For the sake of mathematical correctness, it is noted that the logarithm formation leads to integral values and not to elements of the finite field. However, this is not relevant to the use of the elements, thus the bits, of the pseudo-random sequences. The definition introduced for the logarithm of 0 results in the logarithm function becoming a bijective (one-to-one) function of GF (p^{m}) over (0, 1, . . . p−1). By logarithmizing using the discrete logarithm to the base α=10, the sequence 11 11 00 10 01 11 10 11 11 10 01 00 11 01 11 11 01 11 11 01 00 10 00 . . . is obtained from the pseudo-random sequence described in connection with FIG. 4. This result is able to be generated using shift-register chain 1 in accordance with FIG. 5.

In place of the multiplication in Galois field GF (q)=GF (2²), an addition modulo 2²−1=3 is essentially performed, and, in place of the addition in the finite field, the operation˜is performed, which is explained in the following. The initial assignment of memory cells 4 in accordance with FIG. 4, is converted by the discrete logarithm into the initial assignment of memory cells 4 of FIG. 5. The method may be suited for binary extension fields. For purely binary shift registers (FIG. 1), it leads only to an exchange of zeros and ones. The following table represents the logic operations in logic element 8′ addition mod 3 and the operation˜for shift register 1 in accordance with FIG. 5, thus for field GF (2²).

| (+) | 0 | 1 | 10 | 11 |
|---|---|---|---|---|
| 0 | 0 | 1 | 10 | 11 |
| 1 | 1 | 10 | 0 | 11 |
| 10 | 10 | 0 | 1 | 11 |
| 11 | 11 | 11 | 11 | 11 |

(+) linking of shift register chain 1 in accordance with FIG. 5

(+) linking of shift register chain 1 in accordance with FIG. 5

| ˜ | 0 | 1 | 10 | 11 |
|---|---|---|---|---|
| 0 | 11 | 10 | 1 | 0 |
| 1 | 10 | 11 | 0 | 1 |
| 10 | 1 | 0 | 11 | 10 |
| 11 | 0 | 1 | 10 | 11 |

˜ linking of shift register chain 1 in accordance with FIG. 5

˜linking of shift register chain 1 in accordance with FIG. 5

The general shift register chain 1 for binary extension fields GF (2) is shown in FIG. 6. Each of the steps is summarized again for shift register chain 1 in accordance with FIG. 6. First, one selects an appropriate shift register chain 1 in accordance with FIG. 3, having operations over field GF(2). The Galois field multiplications are subsequently essentially replaced by an addition modulo 2−1. The difference from addition modulo 2−1 is that for the all-ones assignment, output 3 likewise has the all-ones assignment. The GF(2) addition is replaced by the ˜operation, which is able to be implemented using switching circuit logic or the tables described above. In the case of the table implementation, the so-called Zech logarithm and/or Jacobi logarithm may be used. To obtain the result of operation ˜, one may then set:

i˜j=j˜i=log (αⁱ+α^{j})=i+log α^{(i-z(i-j))} for i>j

i˜j=2−1 for i=j,

the Zech logarithm being defined by equation α^{Z(k)}=1+α^{k}. For field GF (2²), one then obtains the following logarithm table:

i Z(i)

00 11

01 10

10 10

11 00

In summary, a method for generating pseudo-random sequences is able to be provided for all shift-register chains 1 in accordance with FIGS. 1 through 5. The method is essentially based on taking the logarithm of shift-register sequences in a modified, discrete operation. The pseudo-random sequences are generated, not by subsequently taking logarithms (FIGS. 1 through 4), but rather, by directly in the context of generating the pseudo-random sequence, as illustrated in FIGS. 5 and 6. When the size of the considered alphabet, thus the field, is a power of two, for instance, 256, it is possible to represent this alphabet using a byte.

What is claimed is:

1. A method for generating a pseudo-random sequence, where, by using a shift register implemented as hardware or software, having a plurality of series-connected memory cells, elements of the pseudo-random sequence are shifted, the output values of at least two memory cells are linked to one another, and the result of the logic operation is fed back to an input of one of the memory cells of the shift register, wherein the elements (γ) of the pseudo-random sequence are discretely logarithmized.

2. The method as recited in claim 1,
wherein the logarithm is taken in a modified, discrete operation.

3. The method as recited in claim 1 or 2,
wherein the logarithm is taken in a discrete operation already when the output values of the shift registers are logically combined.

4. The method as recited in one of the preceding claims, wherein the logarithm is repeatedly taken in a discrete operation.

5. The method as recited in one of the preceding claims, wherein the logarithmization is carried out discretely on the basis of a table including output and result values.

6. The method as recited in one of the preceding claims, wherein at least one of the output values to be linked to one another is linked in an initial logic operation to a predefinable value, prior to this logic operation.

7. The method as recited in one of the preceding claims, wherein this initial logic operation is a logic operation, preferably an addition operation.

8. The method as recited in one of the preceding claims, wherein the initial logic operation is performed on the basis of an initial-logic-operation table including output and result values, or by using logic circuitry.

9. The method as recited in one of the preceding claims, wherein the discrete logaritmization is carried out using the Zech and/or Jacobi logarithm.

10. The method as recited in one of the preceding claims, wherein the logarithm table is based on the Zech and/or Jacobi logarithm.

11. The method as recited in one of the preceding claims, wherein the feedback operation is carried out in such a way that a pseudo-random sequence having a maximum period length is generated.

12. A device for generating a pseudo-random sequence, comprising a shift register having a plurality of serially connected memory cells, a feedback path, which connects two different register outputs to one register input, and a logic element for the output values of the register, the logic element being connected on the input side to the register outputs and, on the output side, to the register input,
characterized by an element (12) for discretely logarithmizing the elements (γ) of the pseudo-random sequence.

13. The device as recited in claim 12, wherein the element (8′) used for discretely taking logarithms is located in the feedback path (7) and forms the logic element which discretely takes the logarithms of the output values of the register stages (2).

14. The device as recited in claim 12 or 13, wherein the element (8′) is a memory element in which a logarithm table including output and result values is stored.

15. The device as recited in one of claims 12 through 14, wherein situated between one of the register outputs (5) and the logic element (8,8′) is an initial-logic-operation element (14), whose one input (15) is connected to this output (4) of the register stage, whose other input (16) is able to receive a predefinable value, and whose output (17) is connected to the input (10) of the logic element (8,8′).

16. The device as recited in one of claims 12 through 15, wherein the initial-logic-operation element (14) is a logic circuit.
